(19) United States
(12) Patent Application Publication
(10) Pub. No.: US 2016/0316224 A1
(43) Pub. Date: Oct. 27, 2016

(54) Video Encoding Method, Video Decoding Method, Video Encoding Apparatus, Video Decoding Apparatus, Video Encoding Program, And Video Decoding Program

(71) Applicant: NIPPON TELEGRAPH AND TELEPHONE CORPORATION, Tokyo (JP)

(72) Inventors: Shinya SHIMIZU, Yokosuka-shi (JP); Shiori SUGIMOTO, Yokosuka-shi (JP); Akira KOJIMA, Yokosuka-shi (JP)

(73) Assignee: NIPPON TELEGRAPH AND TELEPHONE CORPORATION, Tokyo (JP)

(21) Appl. No.: 15/105,450

(22) PCT Filed: Dec. 24, 2014
(86) PCT No.: PCT/JP2014/084118

§ 371 Date: Jun. 16, 2016

(30) Foreign Application Priority Data
Dec. 27, 2013 (JP) 2013-273523

(51) Int. Cl. H04N 19/61; H04N 19/547; H04N 19/167; H04N 19/597; H04N 19/122

(52) U.S. Cl. CPC H04N 19/61; H04N 19/597; H04N 19/122; H04N 19/167; H04N 19/547

(57) ABSTRACT

A video encoding apparatus is a video encoding apparatus which, when encoding an encoding target picture which is one frame of a multi-view video including videos of a plurality of different views, performs encoding while performing prediction between different views, for each of encoding target areas which are areas into which the encoding target picture is divided, using a reference view picture which is a picture for a reference view different from a view of the encoding target picture and a depth map for an object in the multi-view video, and includes a representative depth setting unit which sets a representative depth from the depth map, a transformation matrix setting unit which sets a transformation matrix that transforms a position on the encoding target picture into a position on the reference view picture based on the representative depth, a representative position setting unit which sets a representative position from a position within each of the encoding target areas, a disparity information setting unit which sets disparity information between the view of the encoding target and the reference view for each of the encoding target areas using the representative position and the transformation matrix, and a prediction picture generation unit which generates a prediction picture for each of the encoding target areas using the disparity information.

### TECHNICAL FIELD

The present invention relates to a video encoding method, a video decoding method, a video encoding apparatus, a video decoding apparatus, a video encoding program, and a video decoding program.

Priority is claimed on Japanese Patent Application No. 2013-273523, filed Dec. 27, 2013, the content of which is incorporated herein by reference.

### BACKGROUND ART

A free viewpoint video is a video in which a user can freely designate a position and a direction (hereinafter referred to as “view”) of a camera within a photographing space. In the free viewpoint video, the user arbitrarily designates the view, and thus videos from all views likely to be designated cannot be retained. Therefore, the free viewpoint video is configured with an information group necessary to generate videos from some views that can be designated. It is to be noted that the free viewpoint video is also called a free viewpoint television, an arbitrary viewpoint video, an arbitrary viewpoint television, or the like.

The free viewpoint video is expressed using a variety of data formats, but there is a scheme using a video and a depth map (distance picture) corresponding to a frame of the video as the most general format (see, for example, Non-Patent Document 1). The depth map expresses, for each pixel, a depth (distance) from a camera to an object. The depth map expresses a three-dimensional position of the object.

If a depth satisfies a certain condition, the depth is inversely proportional to a disparity between two cameras (a pair of cameras). Therefore, the depth is also called a disparity map (disparity picture). In the field of computer graphics, the depth becomes information stored in a Z buffer, and thus the depth may also be called a Z picture or a Z map. It is to be noted that instead of the distance from the camera to the object, a coordinate value (Z value) of a Z axis of a three-dimensional coordinate system extended on a space to be expressed may be used as the depth.

If an X-axis is determined as a horizontal direction and a Y-axis is determined as a vertical direction for a captured picture, the Z-axis matches the direction of the camera. However, if a common coordinate system is used for a plurality of cameras, the Z axis may not match the direction of the camera. Hereinafter, the distance and the Z value are referred to as a “depth” without being distinguished. Further, a picture in which the depth is expressed as a pixel value is referred to as a “depth map”. However, strictly speaking, it is necessary for a pair of cameras which becomes a reference to be set for the disparity map.

When the depth is expressed as a pixel value, there is a method using a value corresponding to a physical quantity as the pixel value as is, a method using a value obtained through quantization of the depth when values between a minimum value and a maximum value are quantized in a predetermined number of sections, and a method using a value obtained by quantizing the difference from a minimum value of the depth in a predetermined step size. If a range to be expressed is limited, the depth can be expressed with higher accuracy when additional information such as a minimum value is used.

Further, methods for quantizing the physical quantity at equal intervals include a method for quantizing the physical quantity as is, and a method for quantizing the reciprocal of the physical quantity. The reciprocal of a distance becomes a value proportional to a disparity. Accordingly, if it is necessary for the distance to be expressed with high accuracy, the former is often used, and if it is necessary for the disparity to be expressed with high accuracy, the latter is often used. Hereinafter, a picture in which the depth is expressed is referred to as a “depth map” regardless of the method for expressing the depth as a pixel value and a method for quantizing the depth. Since the depth map is expressed as a picture having one value for each pixel, the depth map can be regarded as a grayscale picture. An object is continuously present in a real space and cannot instantaneously move to a distant position. Therefore, the depth map is said to have a spatial correlation and a temporal correlation, similar to a video signal.

Accordingly, it is possible to effectively code the depth map or a video including continuous depth maps while removing spatial redundancy and temporal redundancy by using a picture coding scheme used to code a picture signal or a video coding scheme used to code a video signal. Hereinafter, the depth map and the video including continuous depth maps are referred to as a “depth map” without being distinguished.

General video coding will be described. In video coding, each frame of the video is divided into processing unit blocks called macroblocks in order to achieve efficient coding using characteristics that an object is continuous spatially and temporally. In video coding, for each macroblock, a video signal is predicted spatially and temporally, and prediction information indicating a method for prediction and a prediction residual are coded.

When the video signal is spatially predicted, information indicating a direction of spatial prediction, for example, becomes the prediction information. When the video signal is temporally predicted, information indicating a frame to be referred to and information indicating a position within the frame, for example, become the prediction information. Since the spatially performed prediction is prediction within the frame, the spatially performed prediction is called intra-frame prediction, intra-picture prediction, or intra prediction.

Since the temporally performed prediction is prediction between frames, the temporally performed prediction is called inter-frame prediction, inter-picture prediction, or inter prediction. Further, the temporally performed prediction is also referred to as motion-compensated prediction because a temporal change in the video, that is, motion is compensated for to predict the video signal.

When a multi-view video including videos obtained by photographing the same scene from a plurality of positions and/or directions is coded, disparity-compensated prediction is used because a change between views in the video, that is, a disparity is compensated for to predict the video signal.

In coding of a free viewpoint video configured with videos based on a plurality of views and depth maps, since both of the videos based on the plurality of views and the depth maps have a spatial correlation and a temporal correlation, an amount of data can be reduced by coding each of the videos based on the plurality of views and the depth maps using a typical video coding scheme. For example, when a multi-view video and depth maps corresponding to the multi-view video are expressed using MPEG-C Part. 3, each of the multi-view video and the depth maps is coded using an existing video coding scheme.

Further, there is a method for achieving efficient coding using a correlation present between views by using disparity information obtained from a depth map when videos based on the plurality of views and depth maps are coded together. For example, Non-Patent Document 2 describes a method for achieving efficient coding by obtaining a disparity vector from a depth map for a processing target area, determining a corresponding area on a previously coded video in another view using the disparity vector, and using a video signal in the corresponding area as a prediction value of a video signal in the processing target area.

### PRIOR ART DOCUMENTS

### Non-Patent Documents

Non-Patent Document 1: Y. Mori, N. Fukusima, T. Fuji, and M. Tanimoto, “View Generation with 3D Warping Using Depth Information for FTV”, In Proceedings of 3DTV-CON2008, pp. 229-232, May 2008.

Non-Patent Document 2: G Tech, K. Wegner, Y. Chen, and S. Yea, “3D-HEVC Draft Text 1”, JCT-3V Doc., JCT3V-E1001 (version 3), September, 2013.

### SUMMARY OF INVENTION

### Problems to be solved by the Invention

According to the method described in Non-Patent Document 2, the value of the depth map is transformed to acquire a highly accurate disparity vector. Accordingly, with the method described in Non-Patent Document 2, highly efficient predictive coding can be realized. However, in the method described in Non-Patent Document 2, when a depth is transformed into the disparity vector, the disparity is assumed to be proportional to the inverse of the depth. More specifically, the disparity is obtained as a product of the inverse of the depth, a focal length of a camera, and the distance between views. Such transformation gives a correct result if two views have the same focal length and the directions of the views (optical axes of cameras) are three-dimensionally parallel, but it gives a wrong result in the other situations.

For accurate transformation, it is necessary to obtain a three-dimensional point by back-projection of a point on a picture onto a three-dimensional space in accordance with a depth and then re-projecting the three-dimensional point onto another view to calculate the point on the picture from the other view, as described in Non-Patent Document 1. However, there is a problem in that such transformation requires complicated computation and the computational complexity increases. That is, efficiency of video coding is low.

In view of the above circumstance, an object of the present invention is to provide a video encoding method, a video decoding method, a video encoding apparatus, a video decoding apparatus, a video encoding program, and a video decoding program capable of improving the accuracy of a disparity vector calculated from a depth map even when the directions of views are not parallel and improving the efficiency of video coding in coding of free viewpoint video data having videos for a plurality of views and depth maps as components.

### Means for Solving the Problems

An aspect of the present invention is a video encoding apparatus which, when encoding an encoding target picture which is one frame of a multi-view video including videos of a plurality of different views, performs encoding while performing prediction between different views, for each of encoding target areas which are areas into which the encoding target picture is divided, using a reference view picture which is a picture for a reference view different from a view of the encoding target picture and a depth map for an object in the multi-view video, and the video encoding apparatus includes: a representative depth setting unit which sets a representative depth from the depth map; a transformation matrix setting unit which sets a transformation matrix that transforms a position on the encoding target picture into a position on the reference view picture based on the representative depth; a representative position setting unit which sets a representative position from a position within each of the encoding target areas; a disparity information setting unit which sets disparity information between the view of the encoding target and the reference view for each of the encoding target areas using the representative position and the transformation matrix; and a prediction picture generation unit which generates a prediction picture for each of the encoding target areas using the disparity information.

Preferably, the aspect of the present invention further includes a depth area setting unit which sets a depth area which is a corresponding area on the depth map for each of the encoding target areas, and the representative depth setting unit sets the representative depth from the depth map for the depth area.

Preferably, the aspect of the present invention further includes a depth reference disparity vector setting unit which sets, for each of the encoding target areas, a depth reference disparity vector which is a disparity vector for the depth map, and the depth area setting unit sets an area indicated by the depth reference disparity vector as the depth area.

Preferably, in the aspect of the present invention, the depth reference disparity vector setting unit sets the depth reference disparity vector using a disparity vector used in encoding of an area adjacent to each of the encoding target areas.

Preferably, in the aspect of the present invention, the representative depth setting unit sets, as the representative depth, a depth indicating being closest to the view of the encoding target picture among depths within the depth area corresponding to pixels at four vertices of each of the encoding target areas.

An aspect of the present invention is a video decoding apparatus which, when decoding a decoding target picture from encoding data of a multi-view video including videos of a plurality of different views, performs decoding while performing prediction between different views, for each of decoding target areas which are areas into which the decoding target picture is divided, using a reference view picture which is a picture for a reference view different from a view of the decoding target picture and a depth map for an object in the multi-view video, and the video decoding apparatus includes: a representative depth setting unit which sets a representative depth from the depth map; a transformation matrix setting unit which sets a transformation matrix that transforms a position on the decoding target picture into a position on the reference view picture based on the representative depth; a representative position setting unit which sets a representative position from a position within each of the decoding target areas; a disparity information setting unit which sets disparity information between the view of the decoding target and the reference view for each of the decoding target areas using the representative position and the transformation matrix; and a prediction picture generation unit which generates a prediction picture for each of the decoding target areas using the disparity information.

Preferably, the aspect of the present invention further includes a depth area setting unit which sets a depth area which is a corresponding area on the depth map for each of the decoding target areas, and the representative depth setting unit sets the representative depth from the depth map for the depth area.

Preferably, the aspect of the present invention further includes a depth reference disparity vector setting unit which sets, for each of the decoding target areas, a depth reference disparity vector which is a disparity vector for the depth map, and the depth area setting unit sets an area indicated by the depth reference disparity vector as the depth area.

Preferably, in the aspect of the present invention, the depth reference disparity vector setting unit sets the depth reference disparity vector using a disparity vector used in decoding of an area adjacent to each of the decoding target areas.

Preferably, in the aspect of the present invention, the representative depth setting unit sets, as the representative depth, a depth indicating being closest to the view of the decoding target picture among depths within the depth area corresponding to pixels at four vertices of each of the decoding target areas.

An aspect of the present invention is a video encoding method for, when encoding an encoding target picture which is one frame of a multi-view video including videos of a plurality of different views, performing encoding while performing prediction between different views, for each of encoding target areas which are areas into which the encoding target picture is divided, using a reference view picture which is a picture for a reference view different from a view of the encoding target picture and a depth map for an object in the multi-view video, and the video encoding method includes: a representative depth setting step of setting a representative depth from the depth map; a transformation matrix setting step of setting a transformation matrix that transforms a position on the encoding target picture into a position on the reference view picture based on the representative depth; a representative position setting step of setting a representative position from a position within each of the encoding target areas; a disparity information setting step of setting disparity information between the view of the encoding target and the reference view for each of the encoding target areas using the representative position and the transformation matrix; and a prediction picture generation step of generating a prediction picture for each of the encoding target areas using the disparity information.

An aspect of the present invention is a video decoding method for, when decoding a decoding target picture from encoding data of a multi-view video including videos of a plurality of different views, performing decoding while performing prediction between different views, for each of decoding target areas which are areas into which the decoding target picture is divided, using a reference view picture which is a picture for a reference view different from a view of the encoding target picture and a depth map for an object in the multi-view video, and the video decoding method includes: a representative depth setting step of setting a representative depth from the depth map; a transformation matrix setting step of setting a transformation matrix that transforms a position on the decoding target picture into a position on the reference view picture based on the representative depth; a representative position setting step of setting a representative position from a position within each of the decoding target areas; a disparity information setting step of setting disparity information between the view of the decoding target and the reference view for the decoding target area using the representative position and the transformation matrix; and a prediction picture generation step of generating a prediction picture for each of the decoding target areas using the disparity information.

An aspect of the present invention is a video encoding program for causing a computer to execute the video encoding method.

An aspect of the present invention is a video decoding program for causing a computer to execute the video decoding method.

### Advantageous Effects of Invention

According to the present invention, it is possible to improve the accuracy of a disparity vector calculated from a depth map even when the directions of views are not parallel and improve efficiency of video coding in coding of free viewpoint video data having videos for a plurality of views and depth maps as components.

### BRIEF DESCRIPTION OF DRAWINGS

FIG. 1 is a block diagram illustrating a configuration of a video encoding apparatus in an embodiment of the present invention.

FIG. 2 is a flowchart illustrating an operation of the video encoding apparatus in an embodiment of the present invention.

FIG. 3 is a flowchart illustrating a process (step S104) in which a disparity vector generation unit generates a disparity vector in an embodiment of the present invention.

FIG. 4 is a flowchart illustrating a process of dividing an encoding target area into sub-areas and generating the disparity vector in an embodiment of the present invention.

FIG. 5 is a block diagram illustrating a configuration of a video decoding apparatus in an embodiment of the present invention.

FIG. 6 is a flowchart illustrating an operation of the video decoding apparatus in an embodiment of the present invention.

FIG. 7 is a block diagram illustrating an example of a hardware configuration when the video encoding apparatus in an embodiment of the present invention is configured with a computer and a software program.

FIG. 8 is a block diagram illustrating an example of a hardware configuration when the video decoding apparatus in an embodiment of the present invention is configured with a computer and a software program.

### MODES FOR CARRYING OUT THE INVENTION

Hereinafter, a video encoding method, a video decoding method, a video encoding apparatus, a video decoding apparatus, a video encoding program, and a video decoding program of an embodiment of the present invention will be described in detail with reference to the accompanying drawings.

In the following description, a multi-view video captured by two cameras (camera A and camera B) is assumed to be encoded. A view from camera A is assumed to be a reference view. Moreover, a video captured by camera B is encoded and decoded frame by frame.

It is to be noted that information necessary for obtaining a disparity from a depth is assumed to be given separately. Specifically, this information is extrinsic parameters expressing a positional relationship between camera A and camera B, intrinsic parameters expressing information on projection onto a picture plane by a camera, or the like. Necessary information may also be given in a different format as long as the information has the same meaning as the above. A detailed description of the camera parameters is given in, for example, a document, Olivier Faugeras, “Three-Dimensional Computer Vision”, pp. 33-66, MIT Press; BCTC/UFF-006.37 F259 1993, ISBN: 0-262-06158-9. In this document, parameters indicating a positional relationship between a plurality of cameras and parameters expressing information on projection onto a picture plane by a camera are described.

In the following description, by adding information capable of specifying a position (for example, a coordinate value, or an index that can be associated with the coordinate value) to a picture, a video frame (picture frame), or a depth map, information to which the information capable of specifying the position is added is assumed to indicate a video signal sampled in a pixel in the position, or a depth based thereon. Further, a value obtained by adding a vector to the index value that can be associated with the coordinate value is assumed to indicate a coordinate value at a position obtained by shifting the coordinate by the vector. Further, a value obtained by adding a vector to an index value that can be associated with a block is assumed to indicate a block at a position obtained by shifting the block by the vector.

First, encoding will be described.

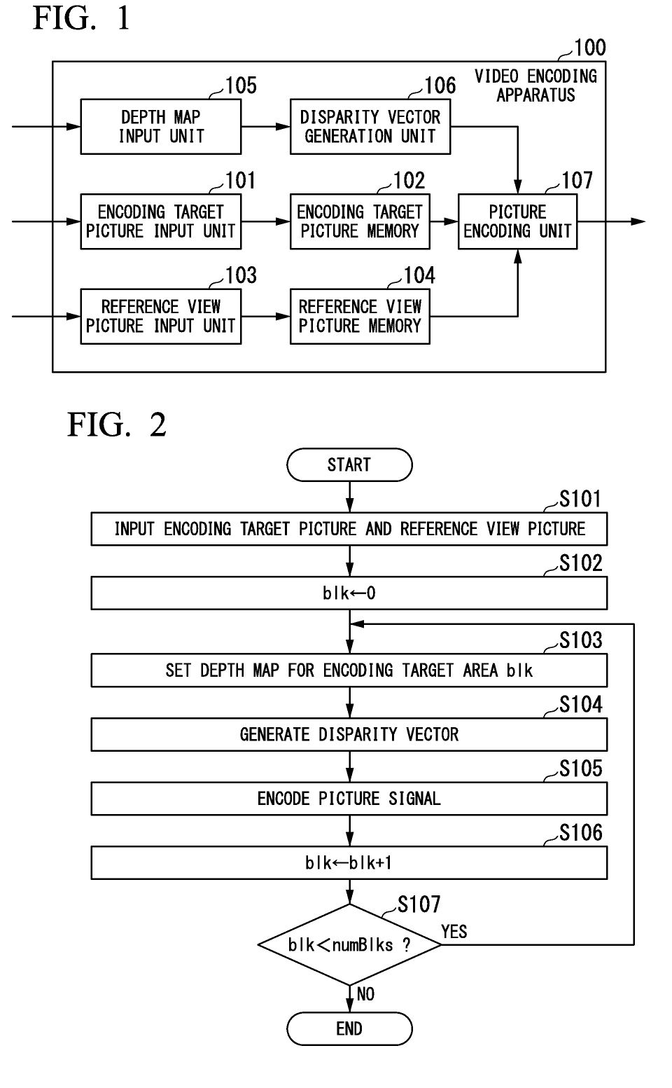

FIG. 1 is a block diagram illustrating a configuration of a video encoding apparatus in an embodiment of the present invention. The video encoding apparatus 100 includes an encoding target picture input unit 101, an encoding target picture memory 102, a reference view picture input unit 103, a reference view picture memory 104, a depth map input unit 105, a disparity vector generation unit 106 (a representative depth setting unit, a transformation matrix setting unit, a representative position setting unit, a disparity information setting unit, a depth area setting unit, and a depth reference disparity vector setting unit), and a picture encoding unit 107 (a prediction picture generation unit).

The encoding target picture input unit 101 inputs a video which is an encoding target to the encoding target picture memory 102 for each frame. Hereinafter, the video which is an encoding target is referred to as an “encoding target picture group”. A frame to be input and encoded is referred to as an “encoding target picture”. The encoding target picture input unit 101 inputs the encoding target picture for each frame from the encoding target picture group captured by camera B. Hereinafter, a view (camera B) from which the encoding target picture is captured is referred to as an “encoding target view”. The encoding target picture memory 102 stores the input encoding target picture.

The reference view picture input unit 103 inputs a video captured from a view (camera A) different from that of the encoding target picture to the reference view picture memory 104. The video captured from the view (camera A) different from that of the encoding target picture is a picture that is referred to when the encoding target picture is encoded. Hereinafter, a view of the picture to be referred to when the encoding target picture is encoded is referred to as a “reference view”. Further, a picture from the reference view is referred to as a “reference view picture”. The reference view picture memory 104 stores the input reference view picture.

The depth map input unit 105 inputs a depth map which is referred to when a disparity vector (information indicating the disparity) is obtained based on a correspondence relationship of pixels between views, to the disparity vector generation unit 106. Here, although the depth map corresponding to the encoding target picture is assumed to be input, a depth map in another view (such as the reference view) may be input.

It is to be noted that a depth map expresses a three-dimensional position of an object included in the encoding target picture for each pixel. The depth map may be expressed using, for example, the distance from a camera to the object, a coordinate value of an axis which is not parallel to the picture plane, or an amount of disparity with respect to another camera (for example, camera A). Here, although the depth map is assumed to be passed in the form of a picture, the depth map may not be passed in the form of a picture as long as the same information can be obtained.

The disparity vector generation unit 106 generates, from the depth map, a disparity vector between an area included in the encoding target picture and an area included in the reference view picture associated with the encoding target picture. The picture encoding unit 107 predictively encodes the encoding target picture based on the generated disparity vector and the reference view picture.

Next, an operation of the video encoding apparatus 100 will be described. FIG. 2 is a flowchart illustrating an operation of the video encoding apparatus 100 in an embodiment of the present invention.

The encoding target picture input unit 101 inputs an encoding target picture Org to the encoding target picture memory 102. The encoding target picture memory 102 stores the encoding target picture Org. The reference view picture input unit 103 inputs a reference view picture Ref to the reference view picture memory 104. The reference view picture memory 104 stores the reference view picture Ref (step S101).

It is to be noted that the reference view picture input here is assumed to be the same reference view picture as that obtained on the decoding end, such as a reference view picture obtained by performing decoding on a reference view picture that has been already encoded. This is because generation of coding noise such as drift is suppressed by using exactly the same information as the reference view picture obtained on the decoding end. However, if the generation of such coding noise is allowed, a reference view picture that is obtained only on the encoding end, such as a reference view picture before encoding, may be input.

When the input of the encoding target picture and the reference view picture ends, the encoding target picture is divided into areas having a predetermined size, and a video signal of the encoding target picture is encoded for each divided area. Hereinafter, each of the areas into which the encoding target picture is divided is called an “encoding target area”. Although the encoding target picture is divided into processing unit blocks which are called macroblocks of 16 pixels×16 pixels, in general encoding, the encoding target picture may be divided into blocks having a different size as long as the size is the same as that on the decoding end. Further, the encoding target picture may be divided into blocks having sizes which are different between the areas instead of dividing the entire encoding target picture in the same size (steps S102 to S107).

In FIG. 2, an encoding target area index is denoted as “blk”. The total number of encoding target areas in one frame of the encoding target picture is denoted as “numBlks”. blk is initialized to 0 (step S102).

In a process repeated for each encoding target area, a depth map corresponding to the encoding target area blk (a depth area which is a corresponding area on the depth map) is first set (step S103).

The depth map is input by the depth map input unit 105. It is to be noted that the input depth map is assumed to be the same as that obtained on the decoding end, such as a depth map obtained by performing decoding on a previously encoded depth map. This is because generation of coding noise such as drift is suppressed by using the same depth map as that obtained on the decoding end. However, if the generation of such coding noise is allowed, a depth map that is obtained only on the encoding end, such as a depth map before encoding, may be input.

Further, in addition to the depth map obtained by performing decoding on the previously encoded depth map, a depth map estimated by applying stereo matching or the like to a multi-view video decoded for a plurality of cameras, or a depth map estimated using the decoded disparity vector, the decoded motion vector, or the like may also be used as the depth map for which the same depth map can be obtained on the decoding end.

Further, although the depth map corresponding to the encoding target area is assumed to be input for each encoding target area in the present embodiment, the depth map in the encoding target area blk may be set by inputting and storing a depth map to be used for the entire encoding target picture in advance and referring to the stored depth map for each encoding target area.

The depth map of the encoding target area blk may be set using any method. For example, when a depth map corresponding to the encoding target picture is used, a depth map in the same position as the position of the encoding target area blk in the encoding target picture may be set, or a depth map in a position shifted by a previously determined or separately designated vector may be set.

It is to be noted that if there is a difference in resolution between the encoding target picture and the depth map corresponding to the encoding target picture, an area scaled in accordance with a resolution ratio may be set or a depth map generated by upsampling, in accordance with the resolution ratio, the area scaled in accordance with the resolution ratio may be set. Further, a depth map corresponding to the same position as the encoding target area in a picture previously encoded in the encoding target view may be set.

It is to be noted that if one of views different from the encoding target view is set as a depth view and a depth map in the depth view is used, an estimated disparity PDV (depth reference disparity vector) between the encoding target view and the depth view in the encoding target area blk is obtained, and a depth map in “blk+PDV” is set. It is to be noted that if there is a difference in resolution between the encoding target picture and the depth map, scaling of the position and the size may be performed in accordance with the resolution ratio.

The estimated disparity PDV between the encoding target view and the depth view in the encoding target area blk may be obtained using any method as long as the method is the same as that on the decoding end. For example, a disparity vector used when an area around the encoding target area blk is encoded, a global disparity vector set for the entire encoding target picture or a partial picture including the encoding target area, or a disparity vector separately set and encoded for each encoding target area may be used. Further, the disparity vector used in a different encoding target area or an encoding target picture previously encoded may be stored, and the stored disparity vector may be used.

Then, the disparity vector generation unit 106 generates a disparity vector of the encoding target area blk using the set depth map (step S104). This process will be described below in detail.

The picture encoding unit 107 encodes a video signal (pixel values) of the encoding target picture in the encoding target area blk while performing prediction using the disparity vector of the encoding target area blk and a reference view picture stored in the reference view picture memory 104 (step S105).

The bit stream obtained as a result of the encoding becomes an output of the video encoding apparatus 100. It is to be noted that any method may be used as the encoding method. For example, if general coding such as MPEG-2 or H.264/AVC is used, the picture encoding unit 107 performs encoding by applying frequency transform such as discrete cosine transform (DCT), quantization, binarization, and entropy encoding on a differential signal between the video signal of the encoding target area blk and the predicted picture in order.

The picture encoding unit 107 adds 1 to blk (step S106).

The picture encoding unit 107 determines whether blk is smaller than numBlks (step S107). If blk is smaller than numBlks (step S107: Yes), the picture encoding unit 107 returns the process to step S103. In contrast, if blk is not smaller than numBlks (step S107: No), the picture encoding unit 107 ends the process.

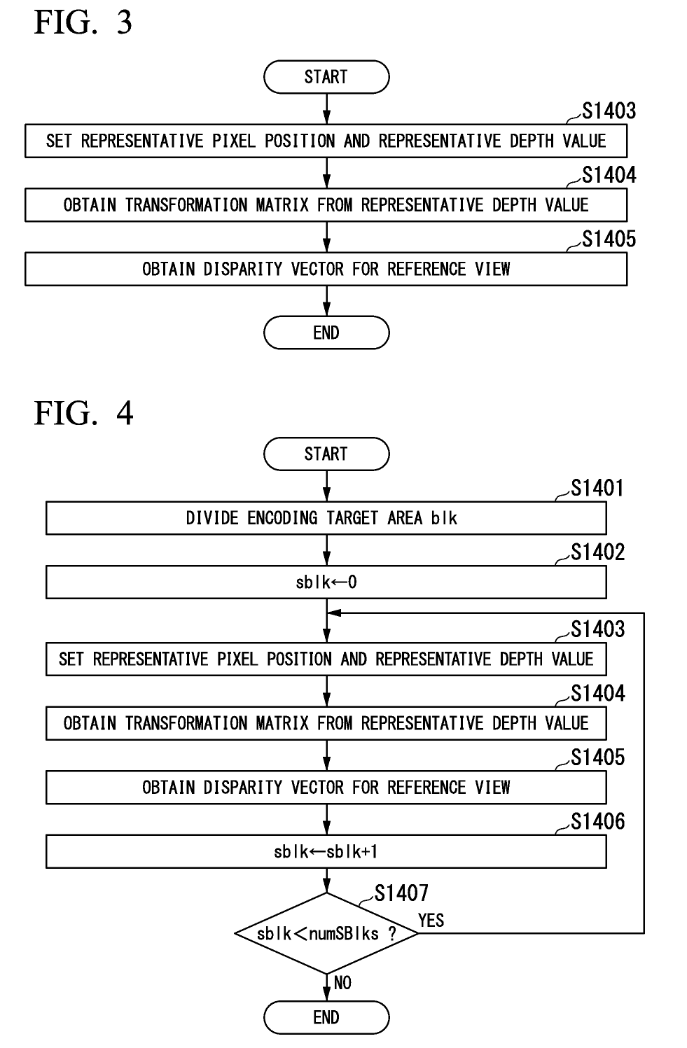

FIG. 3 is a flowchart illustrating a process (step S104) in which the disparity vector generation unit 106 generates a disparity vector in an embodiment of the present invention.

In the process of generating the disparity vector, a representative pixel position pos and a representative depth rep are first set from the depth map of the encoding target area blk (step S1403). Although the representative pixel position pos and the representative depth rep may be set using any method, it is necessary to use the same method as that on the decoding end.

Typical methods for setting the representative pixel position pos include a method for setting a predetermined position such as a center or an upper left in the encoding target area as the representative pixel position, and a method for obtaining a representative depth and then setting the position of a pixel in the encoding target area having the same depth as the representative depth, as the representative pixel position. Further, another method includes a method for comparing depths based on pixels in predetermined positions with one another and setting the position of a pixel having a depth satisfying a predetermined condition. Specifically, there is a method for selecting a pixel which gives a maximum depth, a minimum depth, or a median depth from among four pixels located at a center of the encoding target area, pixels located at four vertices determined in the encoding target area, and pixels located at four vertices determined in the encoding target area and a pixel located at the center.

Typical methods for setting the representative depth rep include a method using, for example, an average value, a median, a maximum value, or a minimum value (a depth indicating being closest to the view of the encoding target picture or a depth indicating being most distant from the view of the encoding target picture, which depends on a definition of the depth) of the depth map of the encoding target area blk. Further, rather than all pixels in the encoding target area, an average value, a median, a maximum value, a minimum value, or the like of depth values based on part of the pixels may also be used. As the part of the pixels, the pixels at four vertices determined in the encoding target area, the pixels located at the four vertices and the pixel located at the center, or the like may be used. Further, there is a method using a depth value based on a position previously determined for the encoding target area, such as the upper left or a center.

When the representative pixel position pos and the representative depth rep are obtained, a transformation matrix Hᵣₑₚ is obtained (step S1404). Here, the transformation matrix is called a homography matrix, and it gives a correspondence relationship between points on picture planes between views when it is assumed that an object is present in a plane expressed by the representative depth. It is to be noted that the transformation matrix Hᵣₑₚ may be obtained using any method. For example, the transformation matrix Hᵣₑₚ can be calculated using Equation (1).

$$\begin{matrix}[ Equation 1 ] & \\ {H}_{rep} = R + \frac{{tn ( {D}_{rep} )}^{T}}{d ( {D}_{rep} )} & ( 1 )\end{matrix}$$

Here, R denotes a 3×3 rotation matrix between the encoding target view and the reference view. t denotes a translation vector between the encoding target view and the reference view. Dᵣₑₚ denotes a representative depth. n(Dᵣₑₚ) denotes a normal vector of a three-dimensional plane corresponding to the representative depth Dᵣₑₚ in the encoding target view. d(Dᵣₑₚ) denotes the distance between the three-dimensional plane and a view center between the encoding target view and the reference view. Further, T as the right superscript denotes the transpose of a vector.

As another method for obtaining the transformation matrix Hᵣₑₚ, corresponding points q, on a picture in the reference view are first obtained based on Equation (2) with respect to four different points p, (i=1, 2, 3, 4) in the encoding target picture.

$$\begin{matrix}[ Equation 2 ] & \\ {P}_{r} ( \begin{matrix}{P}_{t}^{- 1} ( \begin{matrix}{d}_{t} ( {p}_{i} ) ( \begin{matrix}{p}_{i} \\ 1\end{matrix} ) \\ 1\end{matrix} ) \\ 1\end{matrix} ) = s ( \begin{matrix}{q}_{i} \\ 1\end{matrix} ) & ( 2 )\end{matrix}$$

Here, Pₜ and Pᵣ denote 3×4 camera matrices in the encoding target view and the reference view, respectively. Each camera matrix here is given as A[R|t] ([R|t] is a 3×4 matrix generated by arranging R and t, and is referred to as extrinsic parameters of the camera) when intrinsic parameters of the camera are denoted as A, a rotation matrix from a world coordinate system (arbitrary common coordinate system which does not depend on cameras) to a camera coordinate system is denoted as R, and a column vector indicating translation from the world coordinate system to the camera coordinate system is denoted as t. It is to be noted that an inverse matrix P^{H} of the camera matrix P here is a matrix corresponding to inverse transformation of the transformation by the camera matrix P and is expressed as R⁻¹[A⁻¹|−t].

dₜ(pᵢ) denotes the distance on an optical axis from the encoding target view to an object at a point pᵢ when the depth in the point pₜ on the encoding target picture is set as the representative depth.

s is an arbitrary real number. If there is no error in the camera parameters, s is equal to the distance dᵣ(qₜ) on the optical axis at a point qᵢ on the picture of the reference view from the reference view to the object at the point qᵢ.

Further, when Equation (2) is calculated in accordance with the above definition, Equation (3) below is obtained. It is to be noted that subscripts of the intrinsic parameters A, the rotation matrices R, and the translation vectors t denote cameras, and t and r denote the encoding target view and the reference view, respectively.

$$\begin{matrix}[ Equation 3 ] & \\ {A}_{r} ( {R}_{r} {R}_{t}^{- 1} ( {A}_{t}^{- 1} {d}_{t} ( {p}_{i} ) ( \begin{matrix}{p}_{i} \\ 1\end{matrix} ) - {t}_{t} ) + {t}_{r} ) = s ( \begin{matrix}{q}_{i} \\ 1\end{matrix} ) & ( 3 )\end{matrix}$$

When the four corresponding points are obtained, the transformation matrix Hᵣₑₚ is obtained by solving a homogeneous equation obtained in accordance with Equation (4). Here, a component (3, 3) of the transformation matrix Hᵣₑₚ is any real number (e.g., 1).

$$\begin{matrix}[ Equation 4 ] & \\ [ \begin{matrix}{\tilde{p}}_{i}^{T} & {0}^{T} & - {q}_{i , 1} {\tilde{p}}_{i}^{T} \\ {0}^{T} & {\tilde{p}}_{i}^{T} & - {q}_{i , 2} {\tilde{p}}_{i}^{T}\end{matrix} ] [ \begin{matrix}{h}_{1} \\ {h}_{2} \\ {h}_{3}\end{matrix} ] = 0 & ( 4 ) \\ {\tilde{p}}_{i} = ( \begin{matrix}{p}_{i} \\ 1\end{matrix} ) , {q}_{i} = ( \begin{matrix}{q}_{i , 1} \\ {q}_{i , 2}\end{matrix} ) , {H}_{rerp} = [ \begin{matrix}{h}_{1}^{T} \\ {h}_{2}^{T} \\ {h}_{3}^{T}\end{matrix} ] & \end{matrix}$$

The transformation matrix Hᵣₑₚ may be obtained each time the representative depth is obtained since the transformation matrix depends on the reference view and the depth. Further, the transformation matrix Hᵣₑₚ may be obtained for each of combinations of reference views and representative depths before the process for each encoding target area starts, and one transformation matrix may be selected from a group of transformation matrices that have already been calculated, based on the reference view and the representative depth, and set.

When the transformation matrix based on the representative depth is obtained, the position on the reference view is obtained based on Equation (5) and a disparity vector is generated (step S1405).

$$\begin{matrix}[ Equation 5 ] & \\ k ( \begin{matrix}cpos \\ 1\end{matrix} ) = {H}_{rep} ( \begin{matrix}pos \\ 1\end{matrix} ) & ( 5 )\end{matrix}$$

Here, k denotes an arbitrary real number. cpos denotes the position on the reference view. “cpos-pos” denotes the obtained disparity vector. It is to be noted that the position obtained by adding the disparity vector to the position of the encoding target view indicates a corresponding position on the reference view corresponding to the position of the encoding target view. If the corresponding position is expressed by subtracting the disparity vector from the position of the encoding target view, the disparity vector becomes “pos-cpos”. Although the disparity vector is generated for the entire encoding target area blk in the above description, the encoding target area blk may be divided into a plurality of sub-areas and the disparity vector may be generated for each sub-area.

FIG. 4 is a flowchart illustrating a process of dividing the encoding target area into the sub-areas and generating a disparity vector in an embodiment of the present invention.

The disparity vector generation unit 106 divides the encoding target area blk (step S1401).

numSBlks denotes the number of the sub-areas within the encoding target area blk. The disparity vector generation unit 106 initializes a sub-area index “sblk” to 0 (step S1402).

The disparity vector generation unit 106 sets a representative pixel position and a representative depth value (step S1403).

The disparity vector generation unit 106 obtains a transformation matrix from the representative depth value (step S1404).

The disparity vector generation unit 106 obtains a disparity vector for the reference view. That is, the disparity vector generation unit 106 obtains the disparity vector from the depth map of the sub-area sblk (step S1405).

The disparity vector generation unit 106 adds 1 to sblk (step S1406).

The disparity vector generation unit 106 determines whether sblk is smaller than numSBlks (step S1407). If sblk is smaller than numSBlks (step S1407: Yes), the disparity vector generation unit 106 returns the process to step S1403. That is, the disparity vector generation unit 106 repeats steps S1403 to S1407 that obtain a disparity vector from the depth map for each of the sub-areas obtained by the division. In contrast, if sblk is not smaller than numSBlks (step S1407: No), the disparity vector generation unit 106 ends the process.

It is to be noted that the encoding target area blk may be divided using any method as long as the method is the same as that on the decoding end. For example, the encoding target area blk may be divided in a predetermined size (e.g., 4 pixels×4 pixels or 8 pixels×8 pixels) or the encoding target area blk may be divided by analyzing the depth map of the encoding target area blk. For example, the encoding target area blk may be divided by performing clustering based on the values of the depth map. For example, the encoding target area blk may be divided using a variance value, an average value, a maximum value, a minimum value, or the like of the values of the depth map of the encoding target area blk. Further, all pixels in the encoding target area blk may be considered. Further, analysis may be performed on only a set of specific pixels such as a plurality of determined points and/or a center. Further, the encoding target area blk may be divided into the same number of sub-areas for each encoding target area or may be divided into a different number of sub-areas for each encoding target area.

Next, decoding will be described.

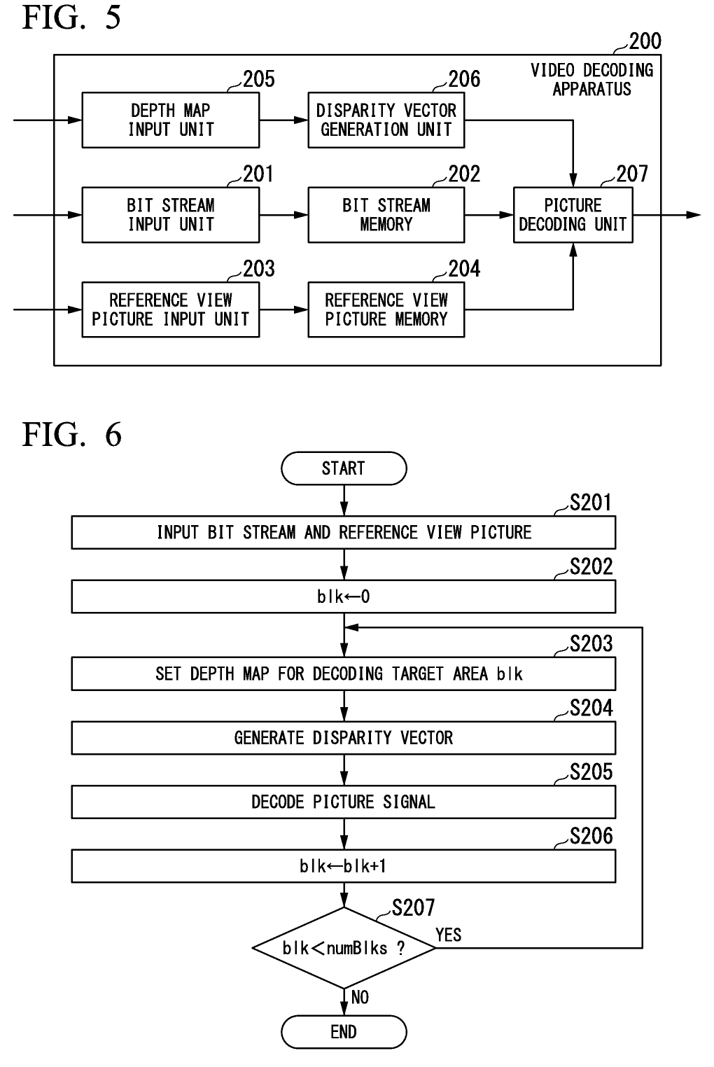

FIG. 5 is a block diagram illustrating a configuration of a video decoding apparatus 200 in an embodiment of the present invention. The video decoding apparatus 200 includes a bit stream input unit 201, a bit stream memory 202, a reference view picture input unit 203, a reference view picture memory 204, a depth map input unit 205, a disparity vector generation unit 206 (a representative depth setting unit, a transformation matrix setting unit, a representative position setting unit, a disparity information setting unit, a depth area setting unit, and a depth reference disparity vector setting unit), and a picture decoding unit 207 (a prediction picture generation unit).

The bit stream input unit 201 inputs a bit stream encoded by the video encoding apparatus 100, that is, a bit stream of a video which is a decoding target to the bit stream memory 202. The bit stream memory 202 stores the bit stream of the video which is the decoding target. Hereinafter, a picture included in the video which is the decoding target is referred to as a “decoding target picture”. The decoding target picture is a picture included in a video (decoding target picture group) captured by camera B. Further, hereinafter, a view from camera B capturing the decoding target picture is referred to as a “decoding target view”.

The reference view picture input unit 203 inputs a picture included in a video captured from a view (camera A) different from that of the decoding target picture to the reference view picture memory 204. The picture based on the view different from that of the decoding target picture is a picture referred to when the decoding target picture is decoded. Hereinafter, a view of the picture referred to when the decoding target picture is decoded is referred to as a “reference view”. A picture of the reference view is referred to as a “reference view picture”. The reference view picture memory 204 stores the input reference view picture.

The depth map input unit 205 inputs a depth map to be referred to when a disparity vector (information indicating the disparity) based on a correspondence relationship of pixels between the views is obtained, to the disparity vector generation unit 206. Here, although the depth map corresponding to the decoding target picture is input, a depth map in another view (for example, reference view) may be input.

It is to be noted that the depth map represents a three-dimensional position of an object included in the decoding target picture for each pixel. The depth map may be expressed using, for example, the distance from a camera to the object, a coordinate value of an axis which is not parallel to the picture plane, or an amount of disparity with respect to another camera (for example, camera A). Here, although the depth map is passed in the form of a picture, the depth map may not be passed in the form of a picture as long as the same information can be obtained.

The disparity vector generation unit 206 generates, from the depth map, a disparity vector between an area included in the decoding target picture and an area included in the reference view picture associated with the decoding target picture. The picture decoding unit 207 decodes the decoding target picture from the bit stream based on the generated disparity vector and the reference view picture.

Next, an operation of the video decoding apparatus 200 will be described. FIG. 6 is a flowchart illustrating an operation of the video decoding apparatus 200 in an embodiment of the present invention.

The bit stream input unit 201 inputs a bit stream obtained by encoding a decoding target picture to the bit stream memory 202. The bit stream memory 202 stores the bit stream obtained by encoding the decoding target picture. The reference view picture input unit 203 inputs a reference view picture Ref to the reference view picture memory 204. The reference view picture memory 204 stores the reference view picture Ref (step S201).

It is to be noted that the reference view picture input here is assumed to be the same reference view picture as that used on the encoding end. This is because generation of coding noise such as drift is suppressed by using exactly the same information as the reference view picture used at the time of encoding. However, if the generation of such coding noise is allowed, a reference view picture different from the reference view picture used at the time of encoding may be input.

When the input of the bit stream and the reference view picture ends, the decoding target picture is divided into areas having a predetermined size, and a video signal of the decoding target picture is decoded from the bit stream for each divided area. Hereinafter, each of the areas into which the decoding target picture is divided is referred to as a “decoding target area”. The decoding target picture is divided into processing unit blocks which are called macroblocks of 16 pixels×16 pixels, in general decoding, but the decoding target picture may be divided into blocks having another size as long as the size is the same as that on the encoding end. Further, the decoding target picture may be divided into blocks having sizes which are different between the areas instead of the entire decoding target picture being divided in the same size (steps S202 to S207).

In FIG. 6, a decoding target area index is indicated by “blk”. The total number of decoding target areas in one frame of the decoding target picture is indicated by “numBlks”. blk is initialized to 0 (step S202).

In the process repeated for each decoding target area, a depth map of the decoding target area blk is first set (step S203).

This depth map is input by the depth map input unit 205. It is to be noted that the input depth map is assumed to be the same depth map as that used on the encoding end. This is because generation of coding noise such as drift is suppressed by using the same depth map as that used on the encoding end. However, if the generation of such coding noise is allowed, a depth map different from that on the encoding end may be input.

As the same depth map as that used on the encoding end, a depth map estimated by applying stereo matching or the like to a multi-view video decoded for a plurality of cameras, a depth map estimated using, for example, a decoded disparity vector or a decoded motion vector, or the like, instead of the depth map separately decoded from the bit stream, can be used.

Further, although the depth map corresponding to the decoding target area is input for each decoding target area in the present embodiment, the depth map to be used for the entire decoding target picture may be input and stored in advance, and the depth map corresponding to the decoding target area blk may be set by referring to the stored depth map for each decoding target area.

The depth map corresponding to the decoding target area blk may be set using any method. For example, if a depth map corresponding to the decoding target picture is used, a depth map in the same position as that of the decoding target area blk in the decoding target picture may be set, or a depth map in a position shifted by a previously determined or separately designated vector may be set.

It is to be noted that if there is a difference in resolution between the decoding target picture and the depth map corresponding to the decoding target picture, an area scaled in accordance with a resolution ratio may be set or a depth map generated by upsampling, in accordance with the resolution ratio, the area scaled in accordance with the resolution ratio may be set. Further, a depth map corresponding to the same position as the decoding target area in a picture previously decoded with respect to the decoding target view may be set.

It is to be noted that if one of views different from the decoding target view is set as a depth view and a depth map in the depth view is used, an estimated disparity PDV between the decoding target view and the depth view in the decoding target area blk is obtained, and a depth map in “blk+PDV” is set. It is to be noted that if there is a difference in resolution between the decoding target picture and the depth map, scaling of the position and the size may be performed in accordance with the resolution ratio.

The estimated disparity PDV between the decoding target view and the depth view in the decoding target area blk may be obtained using any method as long as the method is the same as that on the encoding end. For example, a disparity vector used when an area around the decoding target area blk is decoded, a global disparity vector set for the entire decoding target picture or a partial picture including the decoding target area, or an encoded disparity vector separately set for each decoding target area can be used. Further, a disparity vector used in a different decoding target area or a decoding target picture previously decoded may be stored, and the stored disparity vector may be used.

Then, disparity vector generation unit 206 generates the disparity vector in the decoding target area blk (step S204). This process is the same as step S104 described above except that the encoding target area is read as the decoding target area.

The picture decoding unit 207 decodes a video signal (pixel values) in the decoding target area blk from the bit stream while performing prediction using the disparity vector of the decoding target area blk, and a reference view picture stored in the reference view picture memory 204 (step S205).

The obtained decoding target picture becomes an output of the video decoding apparatus 200. It is to be noted that a method corresponding to the method used at the time of encoding is used for decoding of the video signal. For example, if general coding such as MPEG-2 or H.264/AVC is used, the picture decoding unit 207 applies entropy decoding, inverse binarization, inverse quantization, and inverse frequency transform such as inverse discrete cosine transform (IDCT) to the bit stream in order, adds the prediction picture to the obtained two-dimensional signal, and, finally, clips the obtained value in a range of pixel values, to decode the video signal from the bit stream.

The picture decoding unit 207 adds 1 to blk (step S206).

The picture decoding unit 207 determines whether blk is smaller than numBlks (step S207). If blk is smaller than numBlks (step S207: Yes), the picture decoding unit 207 returns the process to step S203. In contrast, if blk is not smaller than numBlks (step S207: No), the picture decoding unit 207 ends the process.

While the generation of the disparity vector has been performed for each of the areas into which the encoding target picture or the decoding target picture has been divided in the above-described embodiment, the disparity vector may be generated and stored for all areas of the encoding target picture or the decoding target picture in advance, and the stored disparity vector may be referred to for each area.

While the process of encoding or decoding the entire picture has been described in the above-described embodiment, the process may be applied to only part of the picture. In this case, a flag indicating whether the process is applied may be encoded or decoded. Further, the flag indicating whether the process is applied may be designated as any other means. For example, whether the process is applied may be indicated as one of modes indicating a technique of generating a prediction picture for each area.

In the above-described embodiment, the transformation matrix is always generated. However, the transformation matrix does not change as long as the positional relationship between the encoding target view or the decoding target view and the reference view and/or the definition of the depth (a three-dimensional plane corresponding to each depth) are not changed. Therefore, when a set of transformation matrices is determined in advance, it is not necessary to recalculate the transformation matrix for each frame or area.

That is, the positional relationship between the encoding target view and the reference view expressed by separately given camera parameters is compared with the positional relationship between the encoding target view and the reference view expressed by camera parameters in an immediately preceding frame each time the encoding target picture is changed. If there is little or no change in the positional relationship, a set of transformation matrices used for the immediately preceding frame may be used as is, and a set of transformation matrices may be obtained only in the other cases.

Further, a positional relationship between the decoding target view and the reference view expressed by separately given camera parameters is compared with a positional relationship between the decoding target view and the reference view expressed by camera parameters in the immediately preceding frame each time the decoding target picture is changed. If there is little or no change in the positional relationship, a set of transformation matrices used for the immediately preceding frame may be used as is, and a set of transformation matrices may be obtained only in the other cases.

It is to be noted that when the set of transformation matrices is obtained, a transformation matrix based on a reference view having a different positional relationship as compared to the immediately preceding frame and a transformation matrix based on a depth of which the definition has been changed may be identified, and transformation matrices may be recalculated for only the transformation matrices, instead of all transformation matrices being recalculated.

Further, it may be checked only on the encoding end whether or not it is necessary to recalculate the transformation matrices, and a result thereof may be encoded and transmitted. In this case, it may be determined on the decoding end whether the transformation matrices are recalculated based on the transmitted information. Information indicating whether or not recalculation is necessary may be set as one piece of information for the entire frame, may be set for each reference view, or may be set for each depth.

Further, although the transformation matrix is generated for each depth in the above-described embodiment, one depth value may be set as a quantized depth for each of separately-determined sections of a depth value, and the transformation matrix may be set for each quantized depth. By doing so, depth values for which transformation matrices are necessary can be limited to the same depth values as quantized depths, although the representative depth can be any depth value in a range of depths and thus transformation matrices for all the depth values may be necessary. It is to be noted that when the transformation matrix is obtained after the representative depth is obtained, the quantized depth is obtained from the section of depth values which includes the representative depth and the transformation matrix is obtained using the quantized depth. Particularly, if one quantized depth is set for the entire range of depths, the transformation matrix is unique for the reference view.

It is to be noted that the sections of the quantization and the quantized depths may be set using any method as long as the method is the same as that on the decoding end. For example, the range of depths may be evenly divided and a median thereof may be set as a quantized depth. Further, the sections and the quantized depths may be determined in accordance with a distribution of the depths in the depth map.

Further, if the quantized depth is determined using a method which cannot be set on the decoding end, the encoding end may encode and transmit the determined quantization method (the sections and the quantized depths), and the decoding end may decode and obtain the quantization method from the bit stream. It is to be noted that particularly, for example, if one quantized depth is set for the entire depth map, instead of the quantization method, the value of the quantized depth may be encoded or decoded.

Further, although the transformation matrix is generated using the camera parameters or the like even on the decoding end in the above-described embodiment, the transformation matrix calculated and obtained on the encoding end may be encoded and transmitted. In this case, on the decoding end, the transformation matrix is not generated from the camera parameters or the like, and the transformation matrix is acquired through decoding from the bit stream.

Further, although the transformation matrix is always used in the above-described embodiment, the camera parameters may be checked, if the directions are parallel between the views, a look-up table may be generated and transformation of the depth and the disparity vector may be performed in accordance with the look-up table, and if the directions are not parallel between the views, the technique of the invention of the present application may be used. Further, the check may be performed only on the encoding end, and information indicating the used technique may be encoded. In this case, the information is decoded and the used technique is determined on the decoding end.

Further, although one disparity vector is set for each of the areas (the encoding target area or the decoding target area, and the sub-areas thereof) into which the encoding target picture or the decoding target picture is divided in the above-described embodiment, two or more disparity vectors may be set. For example, a plurality of disparity vectors may be generated by selecting a plurality of representative pixels for one area or selecting a plurality of representative depths for one area. Particularly, disparity vectors of both of a foreground and a background may be set by setting two representative depths including a maximum value and a minimum value.

Further, although the homography matrix is used as the transformation matrix in the above-described description, another matrix may be used as long as a pixel position in the encoding target picture or the decoding target picture can be converted into a corresponding pixel position in the reference view. For example, a simplified matrix rather than an exact homography matrix may be used. Further, an affine transformation matrix, a projection matrix, a matrix generated by combining a plurality of transformation matrices, or the like may be used. By using another transformation matrix, it is possible to control accuracy and/or the computational complexity of transformation, an updating frequency of the transformation matrices, a bit amount when the transformation matrices are transmitted, and the like. It is to be noted that in order to prevent generation of coding noise, the same transformation matrices are used at the time of encoding and at the time of decoding.

Next, an example of a hardware configuration when the video encoding apparatus and the video decoding apparatus are configured with a computer and a software program will be described.

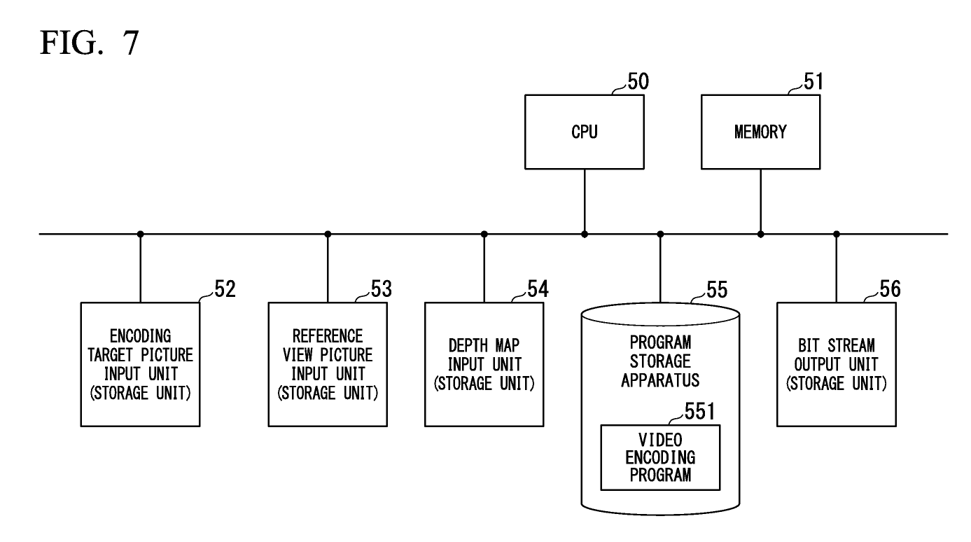

FIG. 7 is a block diagram illustrating an example of a hardware configuration when the video encoding apparatus 100 is configured with a computer and a software program in an embodiment of the present invention. A system includes a central processing unit (CPU) 50, a memory 51, an encoding target picture input unit 52, a reference view picture input unit 53, a depth map input unit 54, a program storage apparatus 55, and a bit stream output unit 56. Each unit is communicably connected via a bus.

The CPU 50 executes the program. The memory 51 is, for example, a random access memory (RAM) in which a program and data accessed by the CPU 50 is stored.

The encoding target picture input unit 52 inputs a video signal which is an encoding target to the CPU 50 from camera B or the like. The encoding target picture input unit 52 may be a storage unit such as a disk apparatus which stores the video signal. The reference view picture input unit 53 inputs a video signal from the reference view such as camera A to the CPU 50. The reference view picture input unit 53 may be a storage unit such as a disk apparatus which stores the video signal.

The depth map input unit 54 inputs a depth map in a view in which an object is photographed by a depth camera or the like, to the CPU 50. The depth map input unit 54 may be a storage unit such as a disk apparatus which stores the depth map. The program storage apparatus 55 stores a video encoding program 551, which is a software program that causes the CPU 50 to execute a video encoding process.

The bit stream output unit 56 outputs a bit stream generated by the CPU 50 executing the video encoding program 551 loaded from the program storage apparatus 55 into the memory 51, for example, over a network. The bit stream output unit 56 may be a storage unit such as a disk apparatus which stores the bit stream.

The encoding target picture input unit 101 corresponds to the encoding target picture input unit 52. The encoding target picture memory 102 corresponds to the memory 51. The reference view picture input unit 103 corresponds to the reference view picture input unit 53. The reference view picture memory 104 corresponds to the memory 51. The depth map input unit 105 corresponds to the depth map input unit 54. The disparity vector generation unit 106 corresponds to the CPU 50. The picture encoding unit 107 corresponds to the CPU 50.

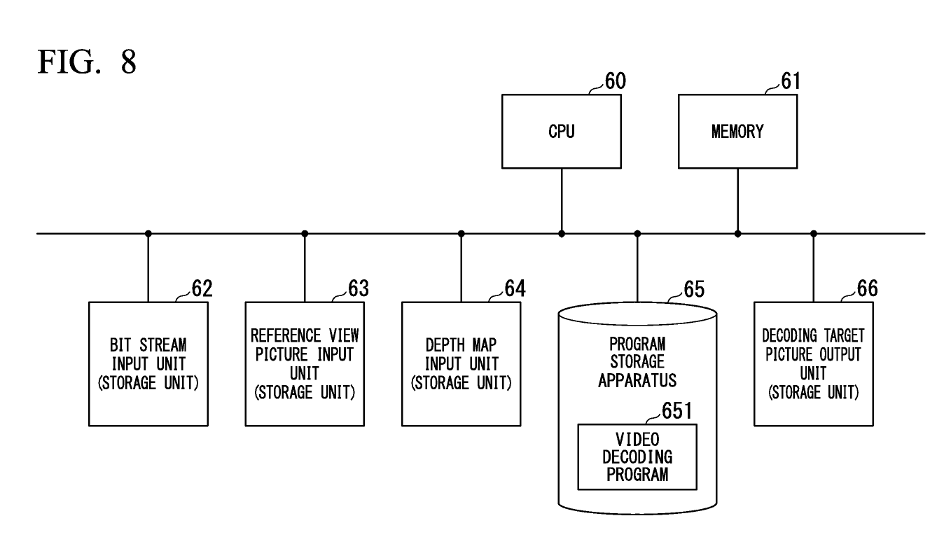

FIG. 8 is a block diagram illustrating an example of a hardware configuration when the video decoding apparatus 200 is configured with a computer and a software program in an embodiment of the present invention. A system includes a CPU 60, a memory 61, a bit stream input unit 62, a reference view picture input unit 63, a depth map input unit 64, a program storage apparatus 65, and a decoding target picture output unit 66. Each unit is communicably connected via a bus.

The CPU 60 executes the program. The memory 61 is, for example, a RAM in which a program and data accessed by the CPU 60 is stored. The bit stream input unit 62 inputs the bit stream encoded by the video encoding apparatus 100 to the CPU 60. The bit stream input unit 62 may be a storage unit such as a disk apparatus which stores the bit stream. The reference view picture input unit 63 inputs a video signal from the reference view such as camera A to the CPU 60. The reference view picture input unit 63 may be a storage unit such as a disk apparatus which stores the video signal.

The depth map input unit 64 inputs a depth map in a view in which an object is photographed by a depth camera or the like, to the CPU 60. The depth map input unit 64 may be a storage unit such as a disk apparatus which stores the depth map. The program storage apparatus 65 stores a video decoding program 651, which is a software program that causes the CPU 60 to execute a video decoding process. The decoding target picture output unit 66 outputs a decoding target picture obtained by performing decoding on the bit stream by the CPU 60 executing a video decoding program 651 loaded into the memory 61 to a reproduction apparatus or the like. The decoding target picture output unit 66 may be a storage unit such as a disk apparatus which stores the video signal.

The bit stream input unit 201 corresponds to the bit stream input unit 62. The bit stream memory 202 corresponds to the memory 61. The reference view picture input unit 203 corresponds to the reference view picture input unit 63. The reference view picture memory 204 corresponds to the memory 61. The depth map input unit 205 corresponds to the depth map input unit 64. The disparity vector generation unit 206 corresponds to the CPU 60. The picture decoding unit 207 corresponds to the CPU 60.

The video encoding apparatus 100 and the video decoding apparatus 200 in the above-described embodiment may be achieved by a computer. In this case, the apparatus may be achieved by recording a program for achieving the above-described functions on a computer-readable recording medium, loading the program recorded on the recording medium into a computer system, and executing the program. It is to be noted that the “computer system” referred to here includes an operating system (OS) and hardware such as a peripheral device. Further, the “computer-readable recording medium” refers to a portable medium such as a flexible disk, a magneto-optical disc, a read only memory (ROM), or a compact disc (CD)-ROM, or a storage apparatus such as a hard disk embedded in the computer system. Further, the “computer-readable recording medium” may also include a recording medium that dynamically holds a program for a short period of time, such as a communication line when the program is transmitted over a network such as the Internet or a communication line such as a telephone line or a recording medium that holds a program for a certain period of time, such as a volatile memory inside a computer system which functions as a server or a client in such a case. Further, the program may be a program for achieving part of the above-described functions or may be a program capable of achieving the above-described functions through a combination with a program prestored in the computer system. Further, the video encoding apparatus 100 and the video decoding apparatus 200 may be achieved using a programmable logic device such as a field programmable gate array (FPGA).

While an embodiment of the present invention have been described above in detail with reference to the accompanying drawings, a specific configuration is not limited to the embodiment, and designs and the like without departing from the gist of the present invention are also included.

### INDUSTRIAL APPLICABILITY

The present invention can be applied to, for example, encoding and decoding of the free viewpoint video. In accordance with the present invention, it is possible to improve the accuracy of a disparity vector calculated from a depth map and improve the efficiency of video coding even when directions of views are not parallel in coding of free viewpoint video data having videos for a plurality of views and depth maps as components.

### DESCRIPTION OF REFERENCE SIGNS

50 CPU
51 memory
52 encoding target picture input unit
53 reference view picture input unit
54 depth map input unit
55 program storage apparatus
56 bit stream output unit
60 CPU
61 memory
62 bit stream input unit
63 reference view picture input unit
64 depth map input unit
65 program storage apparatus
66 decoding target picture output unit
100 video encoding apparatus
101 encoding target picture input unit
102 encoding target picture memory
103 reference view picture input unit
104 reference view picture memory
105 depth map input unit
106 disparity vector generation unit
107 picture encoding unit
200 video decoding apparatus
201 bit stream input unit
202 bit stream memory
203 reference view picture input unit
204 reference view picture memory
205 depth map input unit
206 disparity vector generation unit
207 picture decoding unit
551 video encoding program
651 video decoding program

1. A video encoding apparatus which, when encoding an encoding target picture which is one frame of a multi-view video including videos of a plurality of different views, performs encoding while performing prediction between different views, for each of encoding target areas which are areas into which the encoding target picture is divided, using a reference view picture which is a picture for a reference view different from a view of the encoding target picture and a depth map for an object in the multi-view video, the video encoding apparatus comprising:
a representative depth setting unit which sets a representative depth from the depth map;
a transformation matrix setting unit which sets a transformation matrix that transforms a position on the encoding target picture into a position on the reference view picture based on the representative depth;
a representative position setting unit which sets a representative position from a position within each of the encoding target areas;
a disparity information setting unit which sets disparity information between the view of the encoding target and the reference view for each of the encoding target areas using the representative position and the transformation matrix;
a prediction picture generation unit which generates a prediction picture for each of the encoding target areas using the disparity information;
a depth area setting unit which sets a depth area which is a corresponding area on the depth map for each of the encoding target areas; and
a depth reference disparity vector setting unit which sets, for each of the encoding target areas, a depth reference disparity vector which is a disparity vector for the depth map,
wherein the representative depth setting unit sets the representative depth from the depth map for the depth area, and
the depth area setting unit sets an area indicated by the depth reference disparity vector as the depth area.

2. (canceled)

3. (canceled)

4. The video encoding apparatus according to claim 1, wherein the depth reference disparity vector setting unit sets the depth reference disparity vector using a disparity vector used in encoding of an area adjacent to each of the encoding target areas.

5. The video encoding apparatus according to claim 1, wherein the representative depth setting unit sets, as the representative depth, a depth indicating being closest to the view of the encoding target picture among depths within the depth area corresponding to pixels at four vertices of each of the encoding target areas.

6. A video decoding apparatus which, when decoding a decoding target picture from encoding data of a multi-view video including videos of a plurality of different views, performs decoding while performing prediction between different views, for each of decoding target areas which are areas into which the decoding target picture is divided, using a reference view picture which is a picture for a reference view different from a view of the decoding target picture and a depth map for an object in the multi-view video, the video decoding apparatus comprising:
a representative depth setting unit which sets a representative depth from the depth map;
a transformation matrix setting unit which sets a transformation matrix that transforms a position on the decoding target picture into a position on the reference view picture based on the representative depth;
a representative position setting unit which sets a representative position from a position within each of the decoding target areas;
a disparity information setting unit which sets disparity information between the view of the decoding target and the reference view for each of the decoding target areas using the representative position and the transformation matrix;
a prediction picture generation unit which generates a prediction picture for each of the decoding target areas using the disparity information;
a depth area setting unit which sets a depth area which is a corresponding area on the depth map for each of the decoding target areas; and
a depth reference disparity vector setting unit which sets, for each of the decoding target areas, a depth reference disparity vector which is a disparity vector for the depth map;
wherein the representative depth setting unit sets the representative depth from the depth map for the depth area, and
the depth area setting unit sets an area indicated by the depth reference disparity vector as the depth area.

7. (canceled)

8. (canceled)

9. The video decoding apparatus according to claim 6, wherein the depth reference disparity vector setting unit sets the depth reference disparity vector using a disparity vector used in decoding of an area adjacent to each of the decoding target areas.

10. The video decoding apparatus according to claim 6, wherein the representative depth setting unit sets, as the representative depth, a depth indicating being closest to the view of the decoding target picture among depths within the depth area corresponding to pixels at four vertices of each of the decoding target areas.

11. A video encoding method for, when encoding an encoding target picture which is one frame of a multi-view video including videos of a plurality of different views, performing encoding while performing prediction between different views, for each of encoding target areas which are areas into which the encoding target picture is divided, using a reference view picture which is a picture for a reference view different from a view of the encoding target picture and a depth map for an object in the multi-view video, the video encoding method comprising:
a representative depth setting step of setting a representative depth from the depth map;
a transformation matrix setting step of setting a transformation matrix that transforms a position on the encoding target picture into a position on the reference view picture based on the representative depth;
a representative position setting step of setting a representative position from a position within each of the encoding target areas;
a disparity information setting step of setting disparity information between the view of the encoding target and the reference view for each of the encoding target areas using the representative position and the transformation matrix;
a prediction picture generation step of generating a prediction picture for each of the encoding target areas using the disparity information;
a depth area setting step of setting a depth area which is a corresponding area on the depth map for each of the encoding target areas; and
a depth reference disparity vector setting step of setting, for each of the encoding target areas, a depth reference disparity vector which is a disparity vector for the depth map,
wherein the representative depth setting step sets the representative depth from the depth map for the depth area, and
the depth area setting step sets an area indicated by the depth reference disparity vector as the depth area.

12. A video decoding method for, when decoding a decoding target picture from encoding data of a multi-view video including videos of a plurality of different views, performing decoding while performing prediction between different views, for each of decoding target areas which are areas into which the decoding target picture is divided, using a reference view picture which is a picture for a reference view different from a view of the encoding target picture and a depth map for an object in the multi-view video, the video decoding method comprising:
a representative depth setting step of setting a representative depth from the depth map;
a transformation matrix setting step of setting a transformation matrix that transforms a position on the decoding target picture into a position on the reference view picture based on the representative depth;
a representative position setting step of setting a representative position from a position within each of the decoding target areas;
a disparity information setting step of setting disparity information between the view of the decoding target and the reference view for the decoding target area using the representative position and the transformation matrix;
a prediction picture generation step of generating a prediction picture for each of the decoding target areas using the disparity information;
a depth area setting step of setting a depth area which is a corresponding area on the depth map for each of the decoding target areas; and
a depth reference disparity vector setting step of setting, for each of the decoding target areas, a depth reference disparity vector which is a disparity vector for the depth map;
wherein the representative depth setting step sets the representative depth from the depth map for the depth area, and
the depth area setting step sets an area indicated by the depth reference disparity vector as the depth area.

13. (canceled)

14. (canceled)

15. A video encoding apparatus which, when encoding an encoding target picture which is one frame of a multi-view video including videos of a plurality of different views, performs encoding while performing prediction between different views, for each of encoding target areas which are areas into which the encoding target picture is divided, using a reference view picture which is a picture for a reference view different from a view of the encoding target picture and a depth map for an object in the multi-view video, the video encoding apparatus comprising:
a representative depth setting unit which sets a representative depth from the depth map;
a transformation matrix setting unit which sets a transformation matrix that transforms a position on the encoding target picture into a position on the reference view picture based on the representative depth;
a representative position setting unit which sets a representative position from a position within each of the encoding target areas;
a disparity information setting unit which sets disparity information between the view of the encoding target and the reference view for each of the encoding target areas using the representative position and the transformation matrix; and
a prediction picture generation unit which generates a prediction picture for each of the encoding target areas using the disparity information,
wherein the transformation matrix setting unit recalculates the transformation matrix if a change in a positional relationship between the view of the encoding target picture and the reference view is greater than a predetermined value.

16. A video decoding apparatus which, when decoding a decoding target picture from encoding data of a multi-view video including videos of a plurality of different views, performs decoding while performing prediction between different views, for each of decoding target areas which are areas into which the decoding target picture is divided, using a reference view picture which is a picture for a reference view different from a view of the decoding target picture and a depth map for an object in the multi-view video, the video decoding apparatus comprising:
a representative depth setting unit which sets a representative depth from the depth map;
a transformation matrix setting unit which sets a transformation matrix that transforms a position on the decoding target picture into a position on the reference view picture based on the representative depth;
a representative position setting unit which sets a representative position from a position within each of the decoding target areas;
a disparity information setting unit which sets disparity information between the view of the decoding target and the reference view for each of the decoding target areas using the representative position and the transformation matrix; and
a prediction picture generation unit which generates a prediction picture for each of the decoding target areas using the disparity information,
wherein the transformation matrix setting unit recalculates the transformation matrix if a change in a positional relationship between the view of the decoding target picture and the reference view is greater than a predetermined value.

17. A video encoding method for, when encoding an encoding target picture which is one frame of a multi-view video including videos of a plurality of different views, performing encoding while performing prediction between different views, for each of encoding target areas which are areas into which the encoding target picture is divided, using a reference view picture which is a picture for a reference view different from a view of the encoding target picture and a depth map for an object in the multi-view video, the video encoding method comprising:
a representative depth setting step of setting a representative depth from the depth map;
a transformation matrix setting step of setting a transformation matrix that transforms a position on the encoding target picture into a position on the reference view picture based on the representative depth;
a representative position setting step of setting a representative position from a position within each of the encoding target areas;
a disparity information setting step of setting disparity information between the view of the encoding target and the reference view for each of the encoding target areas using the representative position and the transformation matrix; and
a prediction picture generation step of generating a prediction picture for each of the encoding target areas using the disparity information,
wherein the transformation matrix setting step recalculates the transformation matrix if a change in a positional relationship between the view of the encoding target picture and the reference view is greater than a predetermined value.

18. A video decoding method for, when decoding a decoding target picture from encoding data of a multi-view video including videos of a plurality of different views, performing decoding while performing prediction between different views, for each of decoding target areas which are areas into which the decoding target picture is divided, using a reference view picture which is a picture for a reference view different from a view of the encoding target picture and a depth map for an object in the multi-view video, the video decoding method comprising:
a representative depth setting step of setting a representative depth from the depth map;
a transformation matrix setting step of setting a transformation matrix that transforms a position on the decoding target picture into a position on the reference view picture based on the representative depth;
a representative position setting step of setting a representative position from a position within each of the decoding target areas;
a disparity information setting step of setting disparity information between the view of the decoding target and the reference view for the decoding target area using the representative position and the transformation matrix; and
a prediction picture generation step of generating a prediction picture for each of the decoding target areas using the disparity information,
wherein the transformation matrix setting step recalculates the transformation matrix if a change in a positional relationship between the view of the decoding target picture and the reference view is greater than a predetermined value.

19. A video encoding program for causing a computer to execute the video encoding method according to claim 11.

20. A video decoding program for causing a computer to execute the video decoding method according to claim 12 or 18.

21. The video encoding apparatus according to claim 4, wherein the representative depth setting unit sets, as the representative depth, a depth indicating being closest to the view of the encoding target picture among depths within the depth area corresponding to pixels at four vertices of each of the encoding target areas.

22. The video decoding apparatus according to claim 9, wherein the representative depth setting unit sets, as the representative depth, a depth indicating being closest to the view of the decoding target picture among depths within the depth area corresponding to pixels at four vertices of each of the decoding target areas.

23. A video encoding program for causing a computer to execute the video encoding method according to claim 17.

24. A video decoding program for causing a computer to execute the video decoding method according to claim 18.
